(19) United States
(12) Patent Application Publication
(10) Pub. No.: US 2012/0118670 A1
(43) Pub. Date: May 17, 2012

(54) Retractable Fall Arrest WIth Component Assembly and Cantilevered Main Shaft

(75) Inventors: Wayne L. OLSON, Central Point, OR (US); Gary E. CHOATE, Lakewood, CO (US)

(73) Assignee: Reliance Industries, LLC, Wheat Ridge, CO (US)

(21) Appl. No.: 13/299,317

(22) Filed: Nov. 17, 2011

Related U.S. Application Data
(60) Provisional application No. 61/458,107, filed on Nov. 17, 2010.

(51) Int. Cl. A62B 1/10; A62B 1/00

(52) U.S. Cl. 182/232; 182/3

(57) ABSTRACT

A retractable fall arrest device comprises a unit housing, a spring sub-assembly, a brake/clutch sub-assembly, and a drum assembly. The spring and brake/clutch sub-assemblies each include shaft portions which extend into the housing and are removably connected together or to the drum assembly, and support the drum assembly in the housing. The spring and brake/clutch assembly are themselves removably connected to the unit housing. Finally, the unit housing comprises two wall members (i.e., clam shells) which are removably connected together. This fall arrest device allows for replacement of any of the four constituent components of the device in the field, thus reducing the down time between repairs or recertification of a particular fall arrest device.

### CROSS-REFERENCE TO RELATED APPLICATIONS

This application claims priority to U.S. Prov. App. No. 61/458,107 filed Nov. 17, 2010, which is incorporated herein by reference.

### STATEMENT REGARDING FEDERALLY SPONSORED RESEARCH OR DEVELOPMENT

Not Applicable.

### BACKGROUND OF THE INVENTION

This application relates to fall arrest units, and, in particular to a fall arrest unit comprised of easily assemblable components.

Retractable fall arrests or lifelines have been used for many years and range in size from small (6 ft) units to large (175 ft) units. The purpose of a retractable lifeline or fall arrest unit is to allow workers, who must work on the leading edge of elevated surfaces (or other areas were falls are of concern) to have a means to attach to an overhead anchorage that will arrest their motion in case of an accidental fall. These retractables are usually equipped with a 3/16″ wire rope cable or a 1″ webbing lanyard of at least 4700 lb of anchorage strength. The retractables are equipped with shock absorbers that will limit the forces of a falling worker to 900 lb or less during a fall arrest. These shock absorbers may comprise an internal mechanical clutch type or an external rip-stop type made of webbing. The internal clutch mechanisms usually comprise a stack of friction disks which are held under a known compressive force by preloaded Bellville springs. The internal clutch mechanism normally is activated by a centrifugal pawl mechanism only after the falling worker achieves a certain velocity. The advantage of a mechanical clutch type shock absorber over a webbing rip-stop type shock absorber is that the former will activate much more quickly, which reduces input energy and creates a lower fall arrest force by limiting the worker fall height.

One of the difficulties of using mechanical retractable shock absorbing lifelines is that they must be periodically inspected for damage and be retested to confirm that they are operating correctly. This is usually done yearly and requires each fall arrest unit to be returned to the manufacturer for this recertification service. The reason these units must be returned to the manufacturer is because they are mechanically difficult to service due to the precision setting required on the clutch assembly and the difficulty of unloading and removing the power retraction springs, which may be over 100 ft. long. This is both costly and time consuming, requiring the customer to purchase extra units that can be rotated out of service for recertification on a regular schedule.

These problems are greatly compounded when retractable units are used in off-shore work sites where the retractables will be exposed to a salt (and thus, corrosive) atmosphere. In such conditions, the retractable must be serviced and recertified after approximately four months. Further, when a retractable is being serviced, it is out of commission for about two months.

### BRIEF SUMMARY OF THE INVENTION

Briefly, a retractable fall arrestor is disclosed which is substantially corrosion resistant and which is made from component assemblies, thereby allowing workers in the field to replace any needed component of the retractable. Further, this “field repair” by using component replacement can be accomplished with the use of minimal tools, or preferably with no tools. The replaced components can then be returned to the manufacturer for technical service and recertification, as necessary.

The retractable fall arrest unit comprises a mechanically locking brake assembly component, a retractable power spring assembly component, a central drum and cable assembly component and a housing assembly component that allows the unit to be opened for removal and replacement of the cable drum assembly without requiring disassembly of any of the components. In a preferred embodiment, the unit will be opened around a hinge at a top handle or side of the unit; although the unit can be hinged or pinned for complete separation at any location around the frame assembly. Importantly, the unit can be opened without requiring the removal of a main shaft. Rather, the main shaft is comprised of two cantilevered shafts, one supported by the clutch assembly component and one supported by the spring assembly component. By splitting the main shaft into two cantilevered shafts, the two shafts can be brought together when the housing unit is closed to support the cable drum assembly component. In this way, the cable drum assembly component can be replaced without disassembly of either the spring assembly or the clutch assembly. Additionally, any of the four component assemblies can be replaced without requiring disassembly of any of the other components. Because of this component assembly, the clutch/brake assembly component can be assembled and sealed at the factory and can be permanently lubricated by being made to run in an oil bath. Similarly, the spring assembly component can be assembled and sealed at the factory and made to be permanently lubricated by running in an oil bath. Because the two components are sealed, no contaminates such as dirt, grit, sea water or caustic chemicals, that might attach to the cable can be drawn back into the clutch or spring assemblies. In the preferred embodiment, the housing would be stainless steel with a stainless steel cable and polymer drum to help prevent corrosion, even when used in an offshore environment.

### BRIEF DESCRIPTION OF THE SEVERAL VIEWS OF THE DRAWINGS

FIG. 1 is a cross-sectional view of a first illustrative embodiment of a retractable fall arrest unit;

FIG. 2 is a plan view of the fall arrest unit with the spring assembly removed;

FIG. 3 is an enlarged cross-sectional view of the spring component assembly of the fall arrest unit;

FIG. 4 is an enlarged cross-sectional view of the clutch/brake assembly of the fall arrest unit;

FIGS. 5A and 5B are plan and side views, respectively of a hub component;

FIG. 6 is a cross-sectional view of the drum of the fall arrest unit;

FIG. 7 is a cross-sectional view of a second illustrative embodiment of the fall arrest unit;

FIG. 8 is a plan view of the fall arrest unit of FIG. 7 with the spring assembly removed;

FIG. 9A is a side elevational view of the drum and drive plates of the fall arrest unit of FIG. 7;

FIG. 9B is a plan view of one of the drive plates of the fall arrest unit of FIG. 7

FIG. 10 is a cross-sectional view of the fall arrest unit of FIG. 7, showing the fall arrest unit being opened for service;

FIG. 11 is a cross-sectional view of the fall arrest unit of FIG. 7 provided with an overlay;

FIG. 12 is a plan view of a third embodiment of the fall arrest unit;

FIG. 13 is a cross-sectional view of the fall arrest unit taken along line 13-13 of FIG. 12;

FIG. 14 is a cross-sectional view of the fall arrest unit similar to the view of FIG. 13, but with the drum assembly removed;

FIG. 15 is a side elevational view of the drum and drive plates of the fall arrest unit of FIG. 12;

FIG. 16 is a plan view of one of the drive plates of the fall arrest unit of FIG. 11;

FIG. 17 is a greatly enlarged fragmentary plan view of a pin received in a pin hole of a shaft drive plate in the fall arrest unit of FIG. 12, and demonstrating the effect of a torque applied to the drive plate; and

FIG. 18 is an exploded view of the fall arrest unit.

Corresponding reference numerals will be used throughout the several figures of the drawings.

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

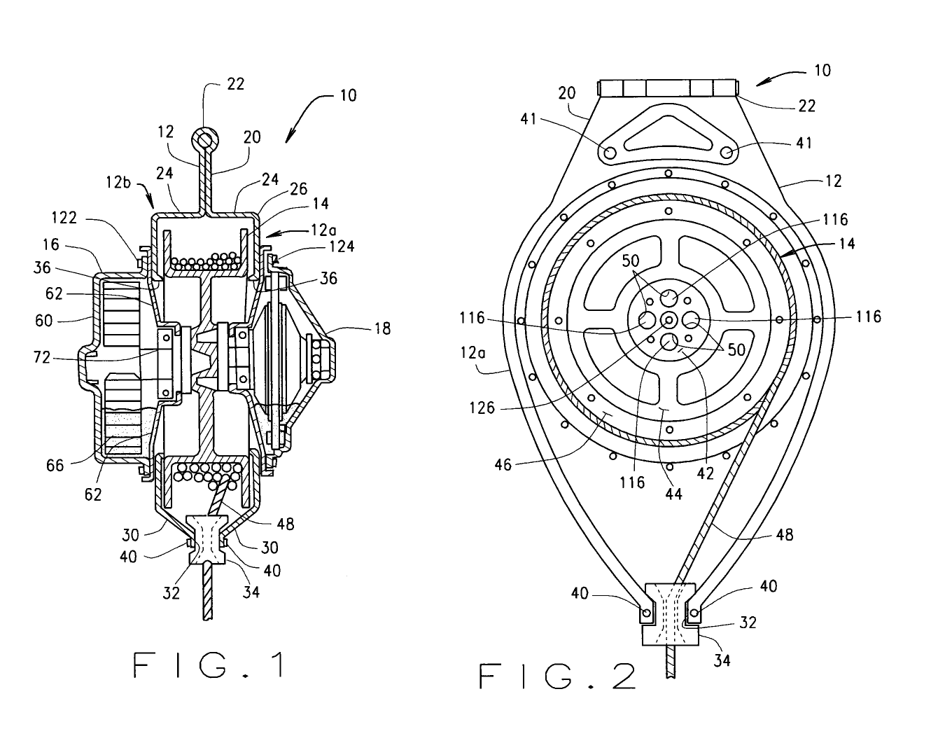

Referring initially to FIG. 1, a retractable fall arrest unit 10 is comprised of four components: a housing 12, a drum 14, a spring sub-assembly 16, and a clutch/brake sub-assembly 18. As will be described in more detail below, the fall arrest unit 10 can be disassembled with few, if any, tools, to allow for replacement of the drum 14 in the field by an operator. Similarly, the spring sub-assembly 16 and clutch/brake sub-assembly 18 can be replaced in the field. Hence, the site where the retractable fall arrest unit 10 is being used need not stock replacement arrest units. Rather, the site need only stock replacement drums and sub-assemblies. This will substantially reduce the down time of a particular retractor.

The housing 12 comprises a first half 12a and a second half 12b. As seen in FIG. 2, the housing 12 is generally tear shaped in plan view. Illustratively, the two housing halves are pivotally connected together by a hinge 22. At its top, the housing includes a handle formed by complementary handle portions 20 in each housing half 12a, 12b. As seen in FIG. 1, the handle portions 20 are adjacent each other. At the bottom of the handle portions, the housing halves define housing top surfaces 24 which extend away the handle portions 20. Outer surfaces 26 extend downwardly from the top surface. At the bottom of the outer surfaces, the housing halves include inwardly sloping surfaces 30 which, at the bottom of the housing, define an opening or outlet 32. A nozzle 34 is positioned at this opening. As can be gleaned from FIGS. 1 and 2, the nozzle 34 is generally centered at the bottom of the housing 12. The housing outer surfaces 26 each define a central opening 36, and the two openings 36 are aligned with each other. As seen in FIG. 1, the housing includes an inwardly turned flange 38 around the periphery of the openings 36.

As noted above, the two housing halves 12a, 12b are connected together at their tops by the hinge 22. The bottoms of the housing halves are held together by screws 40 which extend through the housing halves into the nozzle 34. Hence, each housing half is independently connected to the nozzle (as opposed to being directly connected to each other). As will be described below, because the nozzle is secured to the housing halves, when one of the screws 40 is removed to open the housing, the nozzle 34 will remain connected to the opposite housing half. Additional screws 41 are provided at the handle 20. Although the housing halves 12a, 12b are shown to be hinged together at the top of the housing, the hinge could be placed along a side of the housing. Further, the hinge could be dispensed with altogether, such that the two housing halves can be separated by pulling the two halves apart. In this instance, the housing halves may be provided with positioning pins and holes to facilitate assembly of the housing during a replacement procedure.

The drum 14 comprises a central body 42, a plate or flange 44 extending from the body 42, and a generally U-shaped spool or reel portion 46 at the outer end of the flange 44. The spool portion receives a cable 48, which is wound about the spool portion. When the fall arrest unit is assembled, the drum body 42 and drum flange 44 are generally aligned with the openings 38 in the housing outer surfaces. In fact, the drum body 42 is co-axially aligned with the housing outer openings 38. The spool portion 46 is positioned in the radial outer portion of the unit housing (i.e., radially beyond the openings 38, and the wall of the spool portion is sized to be received in the annular channel defined by the housing wall 24, the outer wall 26, and the peripheral flange 38. As best seen in FIG. 6, the drum assembly body 42 includes a central bore 48 on one side of the body and a plurality of bores 50 on the opposite side of the body 42. The central bore 48 is centered relative to the drum assembly body 42 (and thus centered relative to the housing openings 38). The bores 50, on the opposite side of the body 42) are spaced radially from the central bore 48. For example, there can be four bores 50 spaced around the body 42. The bores 48 and 50 are all preferably shaped as a truncated cone (i.e., have inwardly sloping walls).

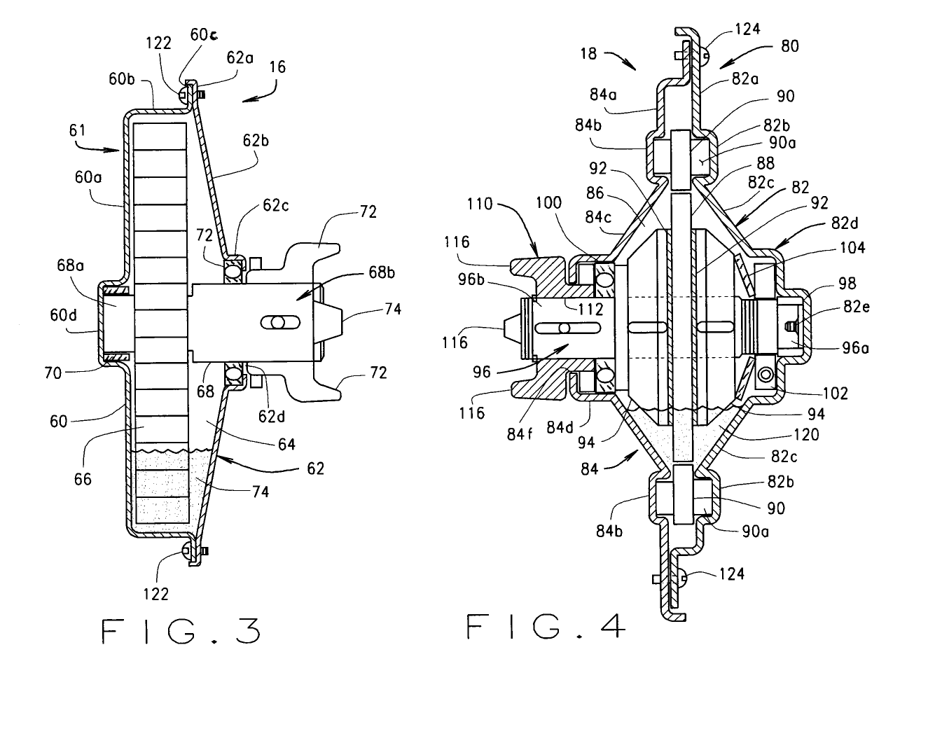

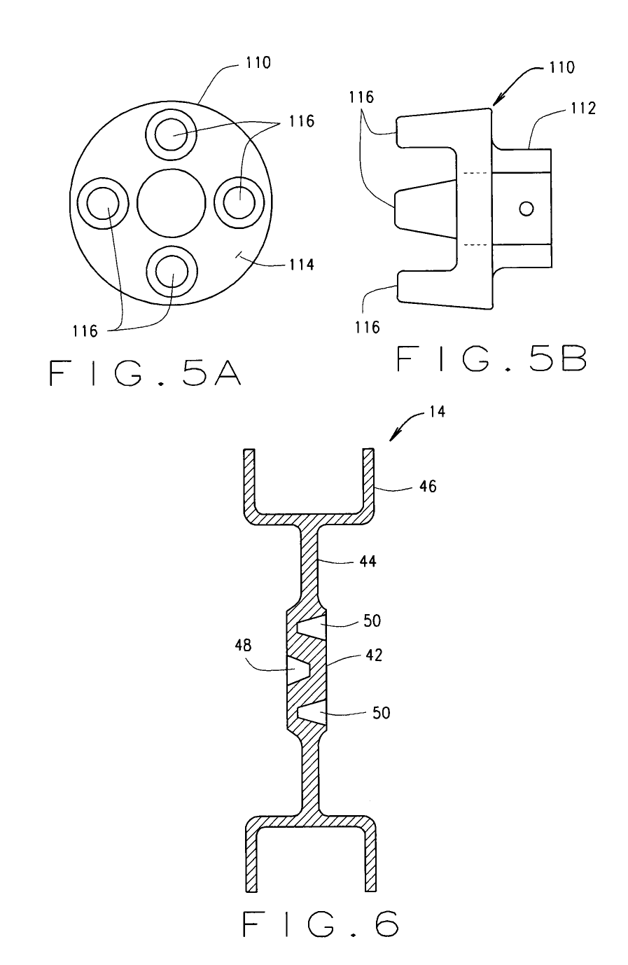

With reference to FIG. 3, the spring sub-assembly 16 includes a spring housing 61 comprising an outer cover 60 and an inner cover 62, which are generally circular in plan. The outer cover 60 includes an outer surface 60a, a side surface 60b, and an attachment flange 60c extending radially outwardly from the side surface 60b. A central, generally cylindrical projection 60d extends from the outer surface 60d of the outer cover 60. An inner cover 62 is secured to the outer cover 60. The inner cover 62 includes an annular attachment flange 62a, and a generally conical surface 62b. An annular shoulder 62c defining a central opening 62d is formed at the center of the inner cover 62. The inner cover 62 and outer cover 60 are connected together along their respective connecting flanges, and when connected, the inner and outer covers define a chamber 64. A spring 66 which is wound about a body (not shown) is received in the chamber 64. The spring 66 can be a single spring for smaller retractables or a plurality of springs connected together in series for larger retractables.

A cantilevered spring shaft 68 extends through the body, and the body (and thus the spring) is positionally fixed to the shaft 68, such that the center (or first end) of the spring and shaft rotate together. The other end of the spring is secured to the housing 60a. The cantilevered spring shaft 68 includes an outer portion 68a which is received in the cylindrical projection 60d of the cover 60 and an inner portion 68b which extends from the spring body through the opening 62d in the inner cover 62. The cantilevered spring shaft is rotationally supported in the housing 61 by a roller bearing 70 at the spring shaft outer end 68a and a ball bearing 72 at the spring shaft inner portion 68b. As seen, the roller bearing 70 is positioned in the cylindrical projection 60d of the housing outer cover 60. The roller bearing can be a tapered roller bearing so as to take thrust loads. The ball bearing 72 is positioned in the bearing shoulder 62c of the housing inner cover 62. The cantilevered spring shaft 68 extends beyond the inner cover 62.

The inner end of the cantilevered spring shaft 68 comprises a central pin 74 which is received in the central opening 48 of the drum body 42 and outer fingers 76 which grippingly engage the drum body 42. The engagement of the fingers 76 with the drum body 42 is such that the drum body 42 (and hence the drum 14) and the spring shaft 68 are rotationally fixed relative to each other. The fingers 76 can be part of a hub that is rotationally fixed relative to the cantilevered spring shaft 68; or the fingers can be integrally formed with the shaft.

The junction between the inner cover 60 and outer cover 62 is preferably sealed, as is the junction between the ball bearing 72 and the inner cover 62. Hence, the spring sub-assembly 16 is a sealed component of the fall arrest unit. The chamber 64 defined by the housing 61 is provided with a lubricant 74, such as oil, so that the spring 66 will remain lubricated and to help prevent corrosion of the spring 66.

The brake/clutch assembly 18 is shown in greater detail in FIG. 4. The clutch/brake assembly 18 includes a brake/clutch housing 80 comprised of an outer cover 82 and an inner cover 84. The outer cover 82 includes an annular generally flat portion 82a with a plurality of generally cylindrical outwardly extending projections 82b formed therein. The projections 82b define a circle. A frustoconical surface 82c extends outwardly from the circle defined by the projections 82b. A first generally cylindrical potion 82d is formed at the outer end of the frustoconical wall 82c; and a second, smaller generally cylindrical portion 82e is formed concentrically with the first generally cylindrical portion 82d. The housing inner cover 84 is shaped complementarily to the outer cover 82. To this end, the inner cover 84 includes an annular generally flat portion 84a with a plurality of generally cylindrical outwardly extending projections 84b formed there in. The projections 84b define a circle, and are positioned to be aligned with the projections 82b of the outer cover 82. A frustoconical surface 84c extends outwardly from the circle defined by the projections 84b. A generally cylindrical wall 82d extends outwardly from the outer end of the frustoconical surface 84c. A flange 84e extends inwardly from the end of the cylindrical wall 84d to define a central opening 84f in the inner cover 84. The opening 84f is aligned with the cylindrical portions 82d and 82e of the outer cover 82. The inner and outer covers are secured together proximate the periphery of the covers 82 and 84 to define an inner chamber 84.

Internally, the brake/clutch assembly includes a sperrad/ratchet plate 88 which is rotationally mounted in the housing 86 and a plurality of pawls 90. The pawls 90 are mounted on pawl axles 90a which are received in the aligned cylindrical projections 82b and 84b of the outer and inner covers, respectively. As can be appreciated, the pawls 90 are sized and shaped to engage teeth (not shown) of ratchet plate, to prevent rotation of the ratchet plate in one direction while allowing for ration of the ratchet plate in the opposite direction. A brake friction disk 92 is positioned on either side of the ratchet plate 88, and brake drums 94 are positioned on either side of the friction pads 92.

A cantilevered brake/clutch shaft 96 extends through the brake drums 94, the brake friction disks 92 and the ratchet plate 88 to rotationally support the brake drums, friction plates, and ratchet plate in the housing 80. The ratchet plate 88 is rotationally fixed to the shaft 96. The shaft 96 includes an outer portion 96a and an inner portion 96b. The shaft outer portion 96a is received in the second cylindrical projection 82e of the housing outer cover 82. The shaft inner portion 96b extends through the opening 84f in the housing inner cover 84. To facilitate rotation of the shaft 96 in the housing, the shaft outer end 96a is supported by roller bearings 98 in the second cylindrical projection 82e of the outer cover 82; and the shaft inner end 96b is supported by ball bearings 100 positioned within the cylindrical wall 84d of the housing inner cover 82. The roller bearing 98 can be a tapered roller bearing to take thrust loads. A Belleville spring lock nut 102 is positioned in the first cylindrical projection 82d of the outer cover, and a Belleville washer 104 (or other spring member) is positioned between the Belleville spring lock nut 102 and the brake drum 94 to preload the brake friction disks 92. The Belleville spring lock nut is rotated to preload the Belleville spring 104. The lock nut includes a set screw which holds the rotational position of the lock nut.

A drive hub 110 is received on the end of the brake/clutch shaft 96. The drive hub 110 includes a hollow sleeve 112 sized to fit over the end of the shaft 96. The sleeve 112 is fixed to the shaft 96, so that the hub and shaft are rotationally fixed relative to each other. A plate or flange 114 extends outwardly from the end of the sleeve 112, and a plurality of drive pins 116 extend forwardly from the flange 114. The pins 116 are generally frustoconical in shape and are sized to be received in the bores 50 of the drum body 42. The brake/clutch shaft 96 is narrower in diameter (at its inner end 96b) than the central opening 84f of the housing inner cover 84. However, the outer diameter of the hub sleeve 112 is sized to be received within the central opening 84f, as seen in FIG. 4. A spacer/seal 118 surrounds the hub sleeve 112 within the cylindrical wall 84d of the inner cover 84, and is positioned between the inner cover flange 84e and the ball bearing assembly 100.

As with the spring assembly, the brake/clutch assembly is sealed, such that the chamber 86 can be provided with an oil bath 120 to help protect the brake/clutch components from corrosion.

Preferably, the connection between the flanges is sealed. To this end, a seal can be provided between the flat annular surfaces 82a and 84a of the outer and inner covers 82 and 84, respectively. Additionally, the seal/spacer 118 will form a seal between the hub sleeve 112 and the housing inner cover 84 to prevent seepage of oil through the opening 84e of the inner cover 84.

With reference to FIG. 1, the spring assembly 16 is secured to the fall arrest housing 12 by means of screws 122 or other fasteners. These are, in part, the same screws which hold the inner and outer covers of the spring housing together. One set of screws holds both sides of the spring housing together, and another set of screws goes through holes in both the inner and outer spring housing plates to attach the spring sub-assembly to the unit housing. The use of the two sets of screws, as just described, allows for the spring sub-assembly to be removed from the unit housing without losing its oil seal. Similarly, the brake/clutch assembly 18 is secured to the fall arrest housing 12 by means of screws 124. As with the spring sub-assembly, there can be two sets of screws: one set which holds the brake/clutch housing together, and another set which secures the brake/clutch housing to the unit housing. Additionally, there is an inner screw 126 (FIG. 3) which extends through the drum body 42 into the cantilevered shaft 68 of the spring assembly.

The spring shaft 68 and the brake/clutch shaft 96 are operatively connected together through the intermediary of the drum body 42. As noted, each shaft 68 and 96 is rotationally fixed to the drum body 42, and hence the two shafts will rotate in unison. When unit 10 is assembled so that the two sides of the housing 12 are closed on the drum 14, there is a tight fit into the center of the drum (i.e., the drum body), so that there is substantially no wobble or looseness in the drum as it rotates during use. The loading

[symbol]

The construction of the fall arrest 10, and in particular, the use of sealed components allows for easy replacement of components in the field. A repair of the fall arrest can be conducted as follows:
1. Place the fall arrest unit 10 on a work surface with the spring assembly 16 down, and the brake/clutch assembly up;
2. Remove the nozzle screws 40 and the handle screws 41.
3. Lift the unit housing half 12a (to which the brake/clutch assembly is mounted) and pivot it about the hinge 22. The drum 14 will stay connected to the spring assembly because of the screw 126.
4. Lift the nozzle out of the spring side 12b of the unit housing 12, and, while holding on to the cable, unwind the cable until all pre-wraps are removed from the power spring 66.
5. Remove the drum screw 126 from the spring side cantilevered shaft 68 and lift the drum assembly out of the fall arrest housing 12 and set aside for replacement if defective.
6. With the housing 12 opened, turn the housing over to expose the outer covers of the spring assembly housing and the brake/clutch assembly housing. As noted below, the unit housing can be adapted so that the spring sub-assembly and the brake/clutch sub-assembly are removed from the inside of the housing, thus negating the need to turn the opened housing assembly over to remove the sub-assemblies from the unit housing. In a unit in which the sub-assemblies are mounted to the inside of the unit housing, even if the screws which held the sub-assemblies to the unit housing were to come out, the sub-assemblies would not separate from the unit housing. This could only happen if the unit housing were opened.
7. Loosen the screws 122 and 124 to remove the spring assembly and the clutch assembly, respectively, from the fall arrest housing 12.

If any of the components are not defective, or do not need servicing, they need not be removed. Any of the components which are defective or which otherwise need servicing can be replaced with spare components. Reassembly is simply conducted in reverse of the steps outlined above. Hence, for example, it may be that only the drum assembly needs replacement. As can be appreciated, the use of the sealed components/assemblies allows for easy field replacement of desired components with the use of only a screw driver. Because the spring 66 is sealed within the spring assembly housing, the worker need not worry about the spring coming unwound. Similarly, the worker need not be concerned about the components of the brake/clutch assembly.

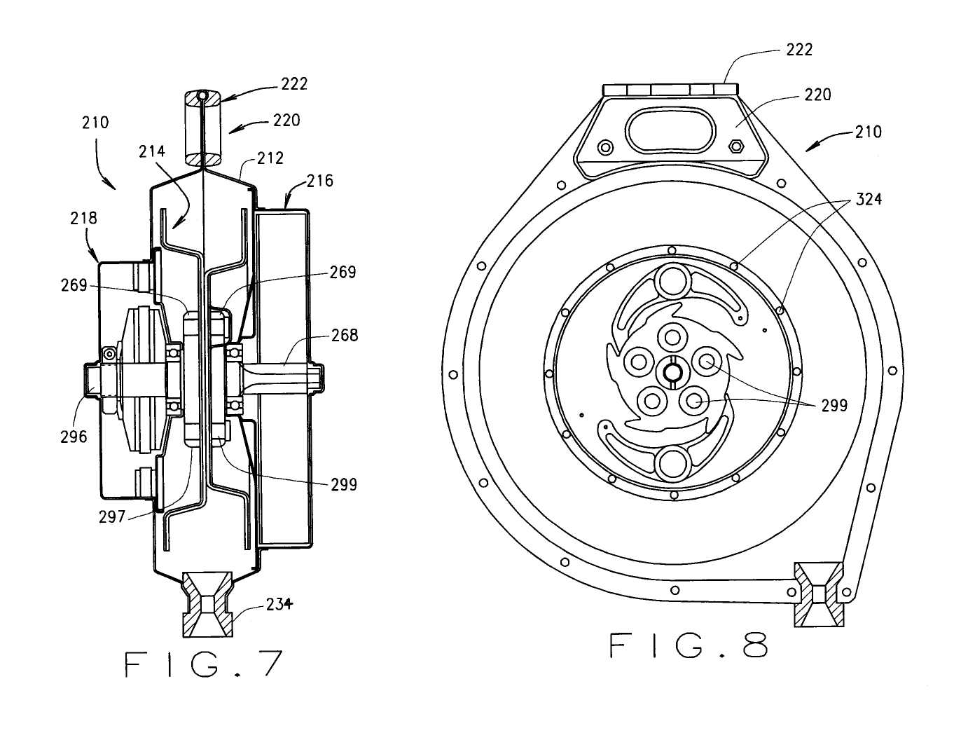

A second illustrative embodiment of the fall arrest is shown in FIGS. 7-9B. The fall arrest 210, like the fall arrest 10, comprises a housing 212 comprised of two sides which are connected together at a handle area 220 by a hinge 222. The fall arrest unit 210 includes a drum assembly 214, a spring assembly 216 and a brake/clutch assembly 218. The housing 212 is generally similar to the housing 12. However, rather than being tear drop shaped, the housing is more circular in plan. This allows for the nozzle 234 to be positioned below the periphery of the drum 214 (rather than centered relative to the drum). This positioning of the nozzle reduces (or substantially eliminates) the bend or angle introduced in the cable as the cable is directed from the drum spool area to the nozzle (which can be seen in FIG. 1). The nozzle 234 is provided with grooves 235, and the housing halves are provided with arced sections 236 which snappingly engage the groove 235 of the nozzle 234. Hence, the screws which connect the nozzle to the housing halves have been eliminated.

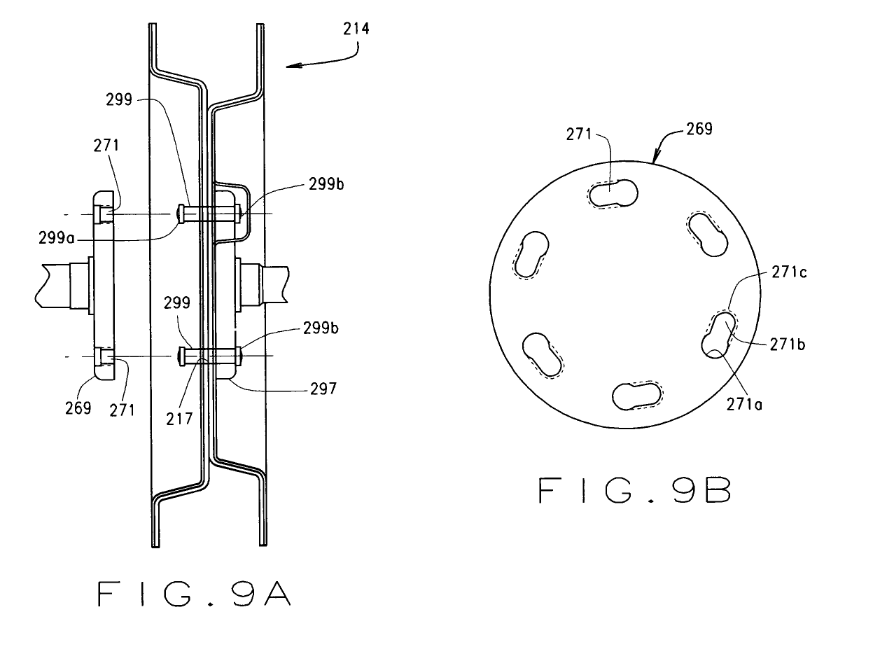

The spring assembly 216 and the brake/clutch assembly 218 are substantially similar to the spring assembly 16 and the brake/clutch assembly 18 of the fall arrest unit 10. However, the drive connection between their respective shafts 268 and 296 and the drum assembly 214 is altered. As seen, the drum assembly is formed from two parts 214a and 214b. These two parts are similar to each other, in that each comprises a central section 215a, a sloping floor section 215b, and a wall section 215c. The floor sections 215b and the wall sections 215c in combination define the spool or reel portion of the drum about which the cable is wound. However, as seen, the central portion 215a of the drum portion 214a is larger in diameter than the central portion of the drum potion 214b. This makes the spool portion deeper on one side of the drum than the other. The central portion of the drum is provided with a plurality of holes 217. (FIG. 9A).

The spring and brake/clutch shafts 268 and 296 are each provided with a drive plate 269 and 297, respectively, which extend from their respective shafts. The plates 269 and 297 can be integral with their respective shafts, or can be separate pieces which are fixed to the shafts. The drive plate 269 is provided with a plurality of key-hole shaped slots 271, each slot 271 including a generally circular head portion 271 a and an elongate leg portion 271 b. The head portion 271a is of constant diameter, and extends through the plate 269. However, the elongate leg portion 271b is undercut to define a ledge 271c. The key hole slots 271 are positioned on the drive plate such that the head portions 271a of the slots can align with the holes 217 in the drum 214. Drive pins 299 extend from the drive plate 269. The pins 299 are positioned on the drive plate 269 to align with the holes 217 of the drum and the key hole slots 271 of the spring drive plate 269. The pins 299 include heads 299a which are sized to pass through the drum holes 217 and through the head portions 271a of the key hole slots 271. However, the pin heads 299a have a diameter greater than the elongate leg 271b extending from the head portion 271a of the key hole slots 271. Rather the pin 271 is sized to extend through the narrower leg slot 27ab. As can be appreciated, when the pin head 299a is passed through the drum hole 217 and the head portion 271a of the key hole slot, if the two drive plates are rotated relative to each other, the pin head 299a will pass from the head portion of the key hole slot to the leg portion of the key hole slot. Here, the pin head will engage the ledge 271c of the key hole slot, and the pin will not be able to be pulled through the slot. The pins 299 thus hold the drive plates 269 and 297 and the drum 214 together. When the fall arrest unit 210 is assembled and operational, the spring of the spring assembly will be preloaded so that it will normally operate to retract the cable into the housing. This preload of the spring will cause the spring to apply a rotational force to the spring drive plate to rotate the spring drive plate relative to the brake/clutch drive plate. This rotational force will maintain the pin heads 299a in engagement with the ledge 271c of the key hole slot 271, thereby substantially maintaining the connection of the drive plates (and hence the spring shaft and brake/clutch shaft) together. Because the spring is applying a torque to the shafts to hold the pins 299 in engagement with the key holes 271, this preload must be overcome to disassemble the unit to replace any of the components. The step 4 noted above (i.e., unwinding of the cable) releases this preload to allow the brake/clutch shaft (and hence the brake/clutch drive plate) to be rotated relative to the spring shaft (and hence the spring drive plate) to bring the pins into alignment with the head opening of the key hole slot. Once the pin heads are aligned with the head opening, the

The pins 299 are describe to extend from the brake/clutch drive plate 297. The fall arrest unit 210 could be constructed such that the pins 299 extend from the spring drive plate and the key hole slots could be in the brake/clutch drive plate. Alternatively, each plate could be provided with both pins and key hole slots. Further, the pins can be integral with the drive plate(s) from which they extend. Alternatively, the pins can be separate from the drive plates. In this instance, the pins would be provided with a second head 299b, and each drive plate 269 and 297 would be provided with key hole slots. In this instance, the key hole slots in each plate would be configured to take advantage of the preload of the spring of the spring sub-assembly, so that the spring would force the pin heads to be engaged in the narrower leg portion of the key hole slots, so that the pin heads will form an interference fit with the ledges of the key hole slots. In another alternative, the pins could extend from the drum, and each of the drive plates could be provided with key-hole slots. Again, the key hole slots would be arranged such that spring would force the pin heads to be engaged in the narrower leg portion of the key hole slots, so that the pin heads will form an interference fit with the ledges of the key hole slots.

Additionally, the screws 322 and 324 which secure the spring sub-assembly and the brake/clutch sub-assembly, respectively to their respective housing halves, have their heads on the inside, rather than the outside of the housing. This allows for these screws to be driven into place (or loosened) to secure the sub-assemblies to the housing halves while the housing is lying opened (and without the need to flip the opened housing, as with the fall arrest unit 10).

As can be appreciated, in the fall arrest unit 210, screws are not used to hold the two housing halves together, nor are screws used to secure the drum 214 in place in the housing 212. Thus, the drum 214 can be replaced without the use of tools. However, at least a screwdriver would be needed to remove and replace the spring assembly 216 and/or the brake/clutch assembly 218.

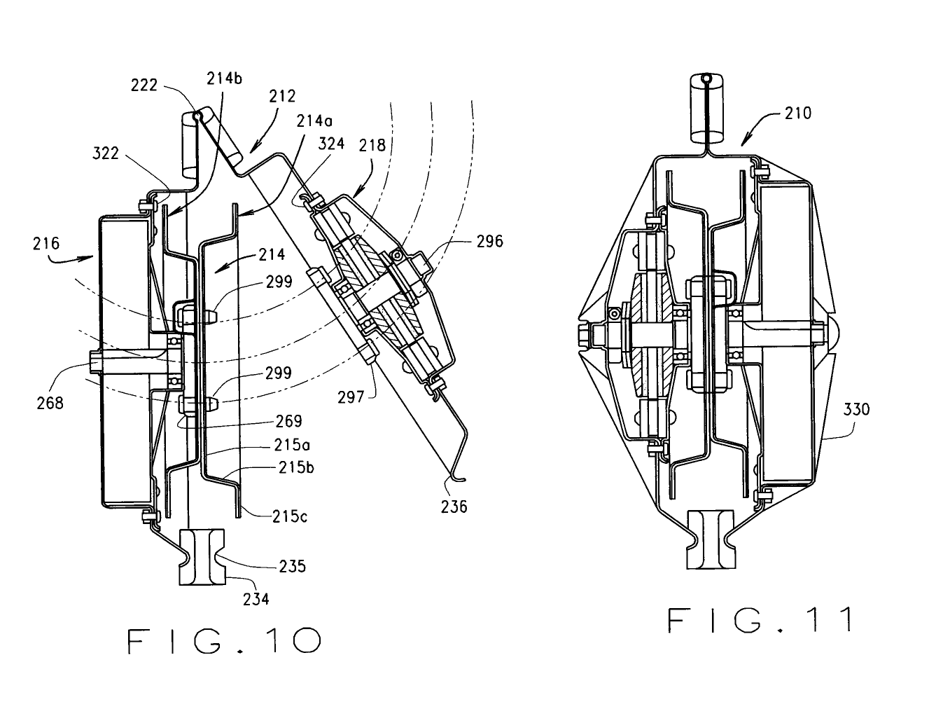

FIG. 11 shows the fall arrest assembly 210 with a plastic cover 330 which substantially surrounds and encapsulates the fall arrest unit 210, while leaving the nozzle 324 open.

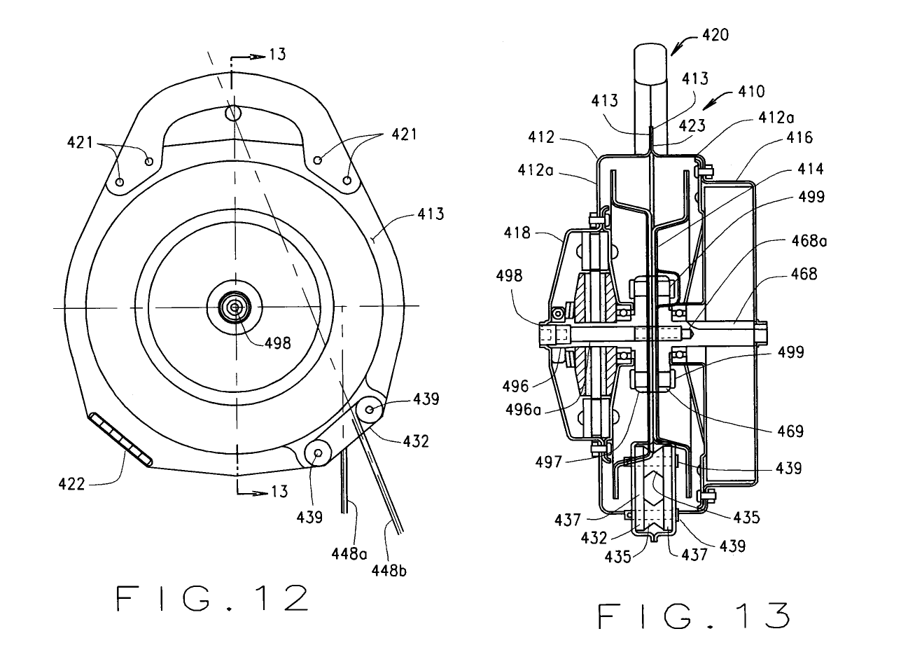

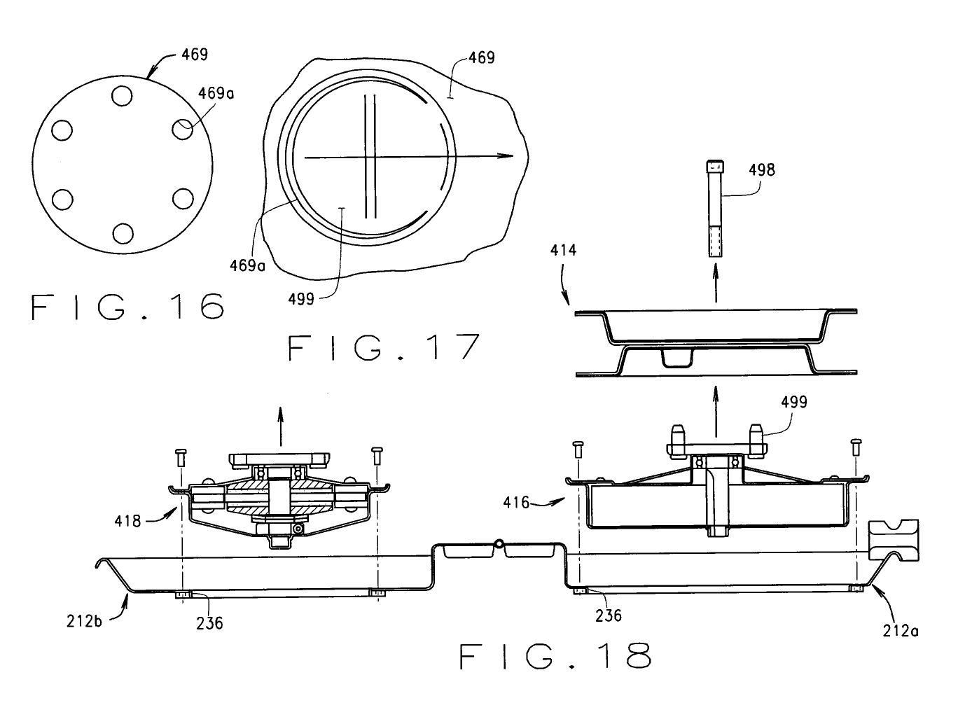

FIGS. 12-17 show a third embodiment 410 of the fall arrest assembly, which is similar in several respects to the fall arrest assembly 210. The spring sub-assembly 416 has a spring shaft with a mounting plate 469 at its inner end which is inside the unit housing chamber when the fall arrest unit is assembled. The brake/clutch sub-assembly includes a brake/clutch shaft with a mounting plate 497 at its inner end. Like the mounting plate 469, the mounting plate 497 is positioned within the chamber of the unit housing. As with the fall arrest unit 210, pins 499 are provided which extend through the mounting plates and the drum assembly 314. In this embodiment, the pins 499 have a positive taper to help with alignment as the two sides 312a and 312b of the unit housing 312 are brought together on the pins, as opposed to the key hole pins or the reverse taper pins of units 10 and 210, respectively.

The housing 412 of the fall arrest unit 410 defines an outlet 432, which is positioned at the bottom, and to side of the housing, as is the outlet in the fall arrest unit 210. It has been found that during use, the cable will readily wear away a plastic nozzle and the cable can be damaged by a steel nozzle. To prevent damage to the cable, the steel nozzle must be hardened, and to protect the steel nozzle from corrosive elements (i.e., salt water), the steel nozzle must be coated, This treatment to the nozzle adds expense to the nozzle, and thus expense to the unit as a whole. Thus, rather than using a nozzle, as in the fall arrest units 10 and 210, the outlet 432 of the fall arrest unit 410 is provided with a pair of spaced apart rollers 435 which are positioned in the outlet 432 by means of shims 437. A pin 439 extends through the housing, the shims and each roller 435 to rotatably mount the rollers in the outlet 432. The pins 432 can, for example, be bolts, but are preferably unthreaded and are secured to the housing be a spring-type connection (i.e., a spring loaded ball or finger which is received in a groove or hole.

In FIG. 12, two cable fragments are depicted. The cable fragment 448a represents the position of the unit's cable when the unit is at rest (i.e., a worker is working normally). In this instance, the cable exits the outlet 432 between the rollers 435, generally without contacting the rollers. The second cable fragment 448b represents the position of the cable when the unit is loaded (i.e., during a fall). In this instance the cable will engage the top roller.

Lastly, with respect to the outlet 432, it can be seen that the outlet is substantially wider than the rollers 435, The width of the outlet allows the same housing to be used with either a cable or a web. As shown, the rollers 435 are generally V-shaped, and are for use with cable. However, by replacing the V-shaped rollers with cylindrical rollers, and by replacing the shims with 437 with thinner shims, the unit can be converted for use with a web rather than a cable.

A handle 420 is mounted to the top of the housing 412. The handle 420 is a separate element with a groove 423 which receives flanges 413 of the housing unit halves 412a and 412b. The handle is secured to the housing by pins 421 which extend through the handle and the housing flanges 413. As with the roller pins 439, the pins 421 can have threaded ends. However, they are preferably removably secured by a spring connection, such as a spring mounted ball or finger which is received in a groove or hole. The pins 439 and 421 are all substantially strong enough to withstand the forces that will be applied to them in a fall. To this extent, the pins can be, for example, ¼″ diameter steel pins.

As best seen in FIG. 12, in the fall arrest unit 410, the hinge 422 is positioned near the bottom of the housing 412, and is approximately level with the housing exit, rather than at the handle as in the units 10 and 210.

As can be appreciated, the two sides 412a and 412b of the housing 412 for the fall assembly 410 are secured together at essentially three locations—the handle 420, the outlet 434 and the hinge 422. Because the pins are secured in place by a spring-type connection, as noted above, the pins can be removed without the use of tools. This allows for opening of the housing without the need for tools. If desired, and as noted above, the pins could have threaded end. However, this would necessitate a tool (in the form of a screw driver, wrench, etc.) to open the housing 412 for replacement of selected assemblies. In one variation, the hinge 422 could be replaced with pins. This would allow for the two pieces of the housing pulled apart, rather than pivoted apart.

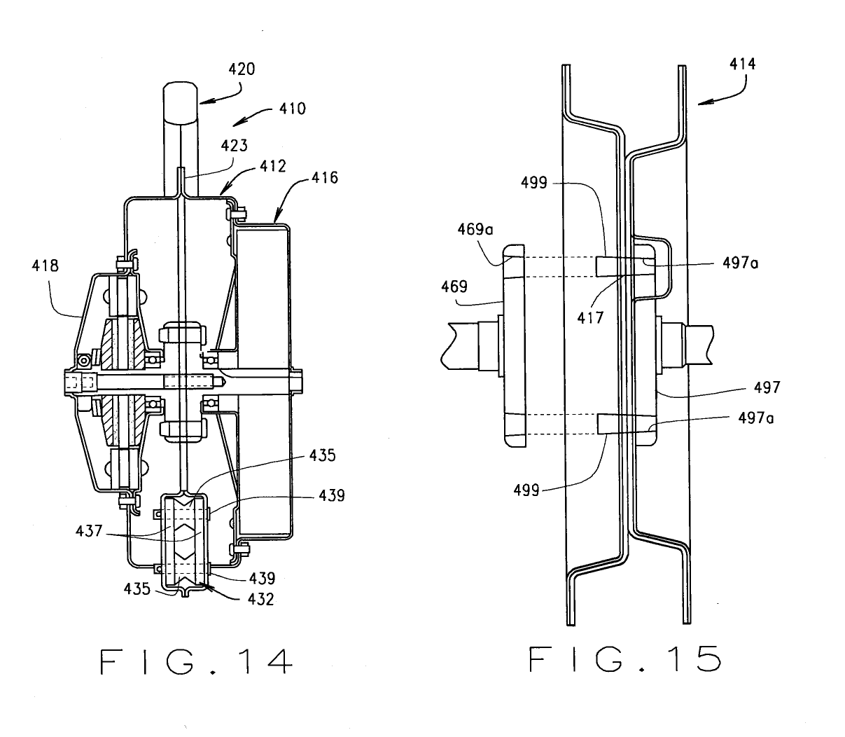

A further difference between the fall arrest units 210 and 410 is in the connection between the shafts 468 and 496. Initially, the spring shaft 368 includes a bore 468a which extends inwardly from the center of the spring shaft mounting plate 469; and the brake/clutch shaft 496 includes a bore 496a which extends through the shaft, and is opened at both the outer end of the shaft (i.e., at the outer wall of the brake/clutch assembly) and at the surface of the brake/clutch mounting plate 497. When the fall arrest unit 410 is assembled, the bores 468a and 496a will be aligned with each other. A retractable bolt 498 extends through the bore 496a of the brake/clutch shaft into the bore 468a of the spring shaft. The end of the bolt will engage the spring shaft bore 468a to, in part, hold the two sides of the unit's housing together. The bolt 498 and the spring shaft bore 468a can both be threaded, such that the bolt is threaded into the bore 468a. Alternatively, as with the pins 439 and 421, the bolt could be provided with a spring mounted ball or finger which is received in a groove or hole in the shaft bore to provide a spring-type connection of the bolt in the shaft bore. This latter variation would allow for removal of the bolt 498 without the need for tools. Additionally, the drive plates 469 and 497 are provided with tapered holes 469a and 497a, respectively, and the pins 499 are tapered, as best shown in FIG. 15. As with the fall arrest unit 210, the drum includes holes 417. The holes 469a and 497a of the drive plates are positioned to align with each other and with the holes 417 of the drum. As seen in FIG. 15, the tapered holes 469a of the spring drive plate 469 have a greater diameter than the tapered holes 497a of the brake/clutch drive plate 497. Additionally, the tapered holes 469a of the spring plate are sized to receive the wide end of the pin 499. When the fall arrest unit 410 is assembled, the tapered pins 499 extend through the spring drive plate, the holes 417 in the drum 414, and the holes 497a of the brake/clutch drive plate 497. The wide end of the pin 499 is received in the hole 469a of the spring drive plate 469, and the narrower end of the pin 499 is received in the holes 497a of the brake/clutch drive plate 497. The spring drive plate holes 469a, as noted, have a diameter slightly larger than the wide end of the pin 499, so as to allow the wide end of the pin to be received into the narrower end of the tapered hole 469a. However, the angle of the taper of the hole 469a corresponds to the angle of the taper of the pin. When the fall arrest unit 410 is loaded (i.e., the spring of the spring assembly applies a torque to the spring shaft and spring drive plate), the torque will push the pins to one side of the hole, as shown in FIG. 17. The interaction of the pins 499 with the holes will generate a force that will hold the assembly (i.e. the spring shaft, the drum, and the brake/clutch shaft) together. Additionally, this interaction will help prevent the unit housing from opening under the force of a fall.

Lastly, FIG. 18 shows a fall arrest assembly in an exploded view. This fall arrest assembly includes the housing 212, the spring sub-assembly 418, the brake/clutch sub-assembly 416 and the drum 414. As seen, the sub-assemblies are inserted into the housing halves 212b and 212a from the inside, and pass through the wall openings 236 in the housing halves. In addition to showing a fall arrest unit in an opened and exploded configuration, FIG. 18 also shows that the sub-assemblies can be used with different housing assemblies.

In view of the above, it will be seen that a retractable fall arrest unit is provided which can be easily disassembled in the field, to replace any of the four components of the fall arrest unit: the housing, the drum, the spring sub-assembly or the brake/clutch sub-assembly. The replaces components can be returned for service or repair. However, because the various components can be replaced in the field, there is very little down time for any particular unit. Hence, rather than having to stock one, two or more complete fall arrest units for each fall arrest unit in use, a site need only stock a supply of components.

As various changes could be made in the above constructions without departing from the scope of the invention, it is intended that all matter contained in the above description or shown in the accompanying drawings shall be interpreted as illustrative and not in a limiting sense. For example, although the shaft is preferably a two part shaft (comprised of the spring shaft and the brake/clutch shaft) the shaft could be a single one-piece shaft. The use of a one-piece shaft will work best when the two housing sides are held together with pins, rather than having a hinged connection, such that the two housing sides can be pulled apart from each other, rather than being pivoted relative to each other. Further, although the spring and brake/clutch sub-assemblies are secured to the housing by means of screws, the sub-assemblies could be secured by pins which are received in key-hole type slots in the unit housing. The sub-assemblies would be placed into the housing, and locked in place by twisting the sub-assembly relative to the housing. This twist-lock would allow for the sub-assemblies to be secured (and removed) without the use of tools. This example is merely illustrative.

1. A retractable fall arrest comprising:
a unit housing comprised of a first side member and a second side member; said first and second side members defining a chamber when assembled; said first and second side members being removably connectable; said housing defining an outlet;
a spring assembly comprising a spring housing; a spring shaft rotatably mounted in said spring housing and a spring member operably fixed to said spring shaft within said spring housing; said spring shaft extending from said spring housing; said spring assembly being removably mounted to said unit housing; said spring shaft extending into said unit housing chamber when said spring assembly is mounted to said housing;
a brake/clutch assembly comprising a brake/clutch housing; a brake/clutch shaft rotatably mounted in said brake/clutch housing, a clutch member operably fixed to said brake/clutch shaft within said brake/clutch housing to rotate within said brake/clutch housing, and a brake member mounted within said brake/clutch housing to reduce and/or stop rotation of said clutch member upon activation of said brake member; said brake/clutch shaft extending from said brake/clutch housing; said brake/clutch assembly being removably mounted to said unit housing; said brake/clutch shaft extending into said unit housing chamber when said brake/clutch assembly is mounted to said housing;
a drum assembly received within said unit housing; said drum assembly comprising a central drum body, a spool portion, and a cable wound around said spool portion; said cable exiting said unit housing through said housing outlet;
wherein said spring shaft and said brake/clutch shaft comprise drive members at inner ends of said shafts; said drive members of said shafts removably connecting said shafts to said drum assembly body to positively engage said drum assembly body such that said drum assembly is rotatably mounted in said unit housing and such that said spring shaft, said brake/clutch shaft and said drum assembly are rotationally fixed relative to each other.

2. The retractable fall arrest of claim 1 wherein said drive members comprise pins which operably extend from one shaft and holes formed at an end of the other shaft; said holes being configured such that preload of the spring of the spring sub-assembly applies a torque which maintains engagement of the pins in the hole.

3. The retractable fall arrest of claim 2 wherein the hole comprises a hey hole slot having head portion and an elongate leg portion 271b, the elongate leg portion defining a slot having a width smaller than the head portion and a ledge having a width greater than the leg slot; the pin comprising a head sized to pass through the key hole slot head portion and to engage the ledge of the key hole slot leg portion.

4. The retractable fall arrest of claim 2 wherein the holes and the pins are both tapered; the holes of one shaft end being larger in diameter than the holes in the other shaft.

5. The retractable fall arrest of claim 1 wherein said first and second members of said unit housing are pivotally connected together along an edge of said unit housing.

6. The retractable fall arrest of claim 1 wherein said first and second members of said housing are removably connected together by means of threaded fasteners.

7. The retractable fall arrest of claim 6 including a nozzle at said unit housing outlet; said outlet being spaced from the pivotal connection of said unit housing first and second members; said fall arrest including at least one threaded fastener which removably extends through said unit housing first member into said nozzle and at least one threaded fastener which removably extends through said unit housing second member into said nozzle.

8. The retractable fall arrest of claim 1 wherein said spring assembly is a sealed assembly.

9. The retractable fall arrest of claim 8 including an oil bath contained within said spring assembly housing; at least a portion of said spring member being in said oil bath when said spring assembly is generally vertically oriented.

10. The retractable fall arrest of claim 1 wherein said brake/clutch assembly is a sealed assembly.

11. The retractable fall arrest of claim 10 including an oil bath contained within said brake/clutch assembly housing; at least a portion of said clutch member and said brake member being in said oil bath when said brake/clutch assembly is generally vertically oriented.

12. The retractable fall arrest of claim 1 wherein the drive member of at least one of said spring shaft and said brake/clutch shaft comprises at least one drive pin extending from said shaft; said drum assembly comprising a hole sized and shaped complementarily to said drive pin to receive said drive pin.

13. The retractable fall arrest of claim 1 including a drive hub rotationally fixed to an inner end of one of said spring shaft and said brake/clutch shaft; said at least one drive pin extending from said drive hub.

14. The retractable fall arrest of claim 1 wherein said drive member comprises a drive plate on the inner end of each of said spring shaft and said brake/clutch shaft, and at least one projection which positively connects said drive plates of said spring shaft and said drive plate shaft to said drum assembly.

15. The retractable fall arrest of claim 14 wherein said at least one projection comprises at least one pin extending through said drive plates and said drum assembly body.

16. A sealed component assembly of a fall arrest device; said sealed component comprising a housing, a shaft rotatably mounted in said housing, and a component member rotationally fixed to said shaft within said component housing; said shaft extending from said housing and having an inner end external of said housing and spaced from a wall of said housing; said inner end of said shaft being adapted to be connected to one or more of a shaft of a second component or a drum of the fall arrest device.

17. The sealed component assembly of claim 16 wherein said shaft includes a drive member at said inner end.

18. The sealed component assembly of claim 16 wherein said drive member comprises a drive pin.

19. The sealed component assembly of claim 18 wherein said drive member comprises a drive hub; said drive pin extending from said hub.

20. The sealed component assembly of claim 16 wherein said drive member includes a drive plate.

21. The sealed component assembly of claim 16 wherein said component assembly is a spring assembly; said spring assembly comprising a spring member operably fixed to said shaft within said housing.

22. The sealed component assembly of claim 16 wherein said component assembly is a brake/clutch assembly; said brake/clutch assembly comprising a clutch member operably fixed to said shaft within said housing to rotate within said housing, and a brake member mounted within said housing to reduce and/or stop rotation of said clutch member upon activation of said brake member.

23. A retractable fall arrest comprising:
a unit housing comprised of a first side member and a second side member; said first and second side members defining a chamber when assembled; said first and second side members being removably connectable; said housing defining an outlet;
a spring assembly comprising a spring housing; a spring member operably fixed to said spring shaft within said spring housing; said spring assembly being removably mounted to said unit housing; a brake/clutch assembly comprising a brake/clutch housing; a clutch member operably fixed to said brake/clutch shaft within said brake/clutch housing to rotate within said brake/clutch housing, and a brake member mounted within said brake/clutch housing to reduce and/or stop rotation of said clutch member upon activation of said brake member; said brake/clutch shaft extending from said brake/clutch housing; said brake/clutch assembly being removably mounted to said unit housing; said brake/clutch shaft extending into said unit housing chamber when said brake/clutch assembly is mounted to said housing;
a drum assembly received within said unit housing; said drum assembly comprising a central drum body, a spool portion, and a cable wound around said spool portion; said cable exiting said unit housing through said housing outlet;
a shaft extending through said spring assembly, said housing and said brake/clutch assembly; said shaft being rotatable relative to said unit housing; said spring member being operatively fixed to said shaft within said spring housing; said clutch member operably being operatively fixed to said shaft within said brake/clutch housing to rotate within said brake/clutch housing.

24. The fall arrest unit of claim 23 wherein said shaft comprises a spring shaft and a brake/clutch shaft; said spring shaft and said brake/clutch shaft each comprising drive members at inner ends of said shafts; said drive members of said shafts being removably connectable to said drum assembly body to positively engaging said drum assembly body such that said drum assembly is rotatably mounted in said unit housing and such that said spring shaft, said brake/clutch shaft and said drum assembly are rotationally fixed relative to each other.
